(19) United States
(12) Patent Application Publication
(10) Pub. No.: US 2026/0257651 A1
(43) Pub. Date: Sep. 3, 2026

(54) VEHICLE CLEANING STRUCTURE

(71) Applicant: Honda Motor Co., Ltd., Tokyo (JP)

(72) Inventors: Takuro SAITO, Tokyo (JP); Keisuke NAKAMA, Tokyo (JP)

(73) Assignee: Honda Motor Co., Ltd., Tokyo (JP)

(21) Appl. No.: 19/457,166

(22) Filed: Jan. 23, 2026

(30) Foreign Application Priority Data
Mar. 3, 2025 (CN) 202510241552.X

(51) Int. Cl. B60S 1/52; B60R 13/00; B60S 1/56

(52) U.S. Cl. CPC B60S 1/52; B60R 13/005; B60S 1/56

(57) ABSTRACT

A vehicle cleaning structure includes: an imaging component, provided above a design surface of a vehicle to acquire external information of the vehicle, and including a lens part; a cleaning component, including an outlet from which a liquid is sprayed toward the lens part; and a shielding structure, provided above the design surface. At least a portion of the outlet of the cleaning component overlaps the lens part in an up-down direction of the vehicle, the shielding structure and the cleaning component are respectively located on opposite sides of the imaging component, and the shielding structure extends along an optical axis of the lens part.

### CROSS-REFERENCE TO RELATED APPLICATION

This application claims the priority benefit of China application serial no. 202510241552.X, filed on March 3, 2025. The entirety of the above-mentioned patent application is hereby incorporated by reference herein and made a part of this specification.

### BACKGROUND

### Technical Field

The present disclosure relates to a vehicle structure, and particularly to a vehicle cleaning structure.

### Related Art

In recent years, efforts to provide access to sustainable transport systems that also consider people in vulnerable positions among traffic participants, such as elderly, disabled, or children, are becoming active. To achieve this purpose, research and development are being conducted to further improve the safety or convenience of traffic through development related to the operability of vehicles. However, in the development related to the operability of vehicles, the appearance (aesthetic quality) of the vehicle is an issue.

Conventionally, an imaging component (for example, a camera) mounted on a vehicle’s exterior is usually provided on an upper side of the vehicle so as to acquire external information of the vehicle in a relatively large range. A cleaning component (for example, a nozzle) for cleaning a lens part of the imaging component mounted on the vehicle’s exterior is provided near the imaging component (that is, on the upper side of the vehicle). To prevent the cleaning component from impairing the appearance of the vehicle’s exterior, there exists a technology in which the cleaning component is configured so that it can be stored inside the vehicle through a sliding mechanism and can be covered by a cover. However, such an approach results in an increased number of parts used in the cleaning component and increased complexity of structure. Accordingly, the above structure has room for improvement in terms of assembly and cost. Furthermore, the above structure has a risk that a liquid sprayed from the cleaning component toward the lens part may splash over a large area through reflection by the lens part. The liquid sprayed from the cleaning component toward the lens part and reflected by the lens part flows widely toward a lateral side and a lower side of the vehicle, which may cause dirt on the vehicle’s exterior and thus affect the appearance (for example, reduce the aesthetic quality) of the vehicle. Accordingly, how to simplify the above structure and prevent the liquid sprayed by the cleaning component from splashing over a large area through reflection by the lens part is a problem being studied by those skilled in the art.

### SUMMARY

A vehicle cleaning structure of the present disclosure includes: an imaging component, provided above a design surface of a vehicle to acquire external information of the vehicle, and including a lens part; a cleaning component, including an outlet from which a liquid is sprayed toward the lens part; and a shielding structure, provided above the design surface. At least a portion of the outlet of the cleaning component overlaps the lens part in an up-down direction of the vehicle. The shielding structure and the cleaning component are respectively located on opposite sides of the imaging component. The shielding structure extends along an optical axis of the lens part.

### BRIEF DESCRIPTION OF THE DRAWINGS

FIG. 1 is a schematic partial perspective view of a vehicle to which a vehicle cleaning structure according to an embodiment of the present disclosure is applied.

FIG. 2 is a schematic front view of the vehicle cleaning structure shown in FIG. 1.

FIG. 3 is a schematic partially enlarged view of the vehicle cleaning structure shown in FIG. 1.

FIG. 4 is a schematic cross-sectional view of the vehicle cleaning structure shown in FIG. 1 at an imaging component.

### DESCRIPTION OF THE EMBODIMENTS

According to the present disclosure, by a simple structure, it is possible to prevent a liquid sprayed by a cleaning component from splashing over a large area through reflection by a lens part. Furthermore, it is possible to improve traffic safety, which contributes to the development of a sustainable transport system.

The present disclosure provides a vehicle cleaning structure in which, by a simple structure, a liquid sprayed by a cleaning component can be prevented from splashing over a large area through reflection by a lens part, while the appearance of a vehicle can be maintained.

The vehicle cleaning structure of the present disclosure includes: an imaging component, provided above a design surface of a vehicle to acquire external information of the vehicle, and including a lens part; a cleaning component, including an outlet from which a liquid is sprayed toward the lens part; and a shielding structure, provided above the design surface. At least a portion of the outlet of the cleaning component overlaps the lens part in an up-down direction of the vehicle. The shielding structure and the cleaning component are respectively located on opposite sides of the imaging component. The shielding structure extends along an optical axis of the lens part.

In an embodiment according to the present disclosure, the design surface is provided with a decorative portion; and the shielding structure arranged above the design surface does not overlap the decorative portion in a direction orthogonal to the up-down direction.

In an embodiment according to the present disclosure, the design surface is provided on a rear surface of the vehicle; and the imaging component is provided at an upper portion of the rear surface of the vehicle.

In an embodiment according to the present disclosure, the design surface includes a glass surface provided on a rear surface of the vehicle.

In an embodiment according to the present disclosure, the design surface includes an information display surface provided on a rear surface of the vehicle.

In an embodiment according to the present disclosure, the vehicle cleaning structure further includes: a lamp component, provided at an upper portion of a rear surface of the vehicle. The lamp component is arranged on a center side compared to the imaging component in a width direction of the vehicle; and the cleaning component is arranged on an outer side than the lens part in the width direction.

In an embodiment according to the present disclosure, the vehicle cleaning structure further includes: a decorative component, provided above the design surface and forming a rear end of an upper surface and an upper end of a rear surface of the vehicle. An upper surface and a rear surface of the decorative component form an acute angle; and the imaging component is provided on the rear surface of the decorative component.

In an embodiment according to the present disclosure, the rear surface of the decorative component is provided with a recess recessed toward a front of the vehicle; the imaging component is provided on a bottom surface of the recess; and the shielding structure is constituted by a side surface of the recess.

In an embodiment according to the present disclosure, the cleaning component is provided in the recess; and a rear end of the cleaning component is located closer to the front of the vehicle than the rear surface of the decorative component.

In an embodiment according to the present disclosure, an included angle formed between a surface of the shielding structure and the optical axis of the lens part is less than or equal to 45 degrees.

Based on the above, in the vehicle cleaning structure of the present disclosure, at least a portion of the outlet of the cleaning component overlaps the lens part of the imaging component in the up-down direction of the vehicle. Accordingly, the cleaning component and the imaging component are arranged adjacent to each other, thereby effectively shortening a liquid spray path from the cleaning component toward the imaging component. The shielding structure and the cleaning component are respectively located on opposite sides of the imaging component. Accordingly, the liquid sprayed from the cleaning component toward the imaging component is blocked by the shielding structure, the liquid blocked by the shielding structure forms a thin strip shaped stream of water that flows along the shielding structure (extending along the optical axis of the lens part) and is prevented from splashing over a large area. Accordingly, in the vehicle cleaning structure of the present disclosure, by a simple structure, the liquid sprayed by the cleaning component can be prevented from splashing over a large area through reflection by the lens part, while the appearance of the vehicle can be maintained.

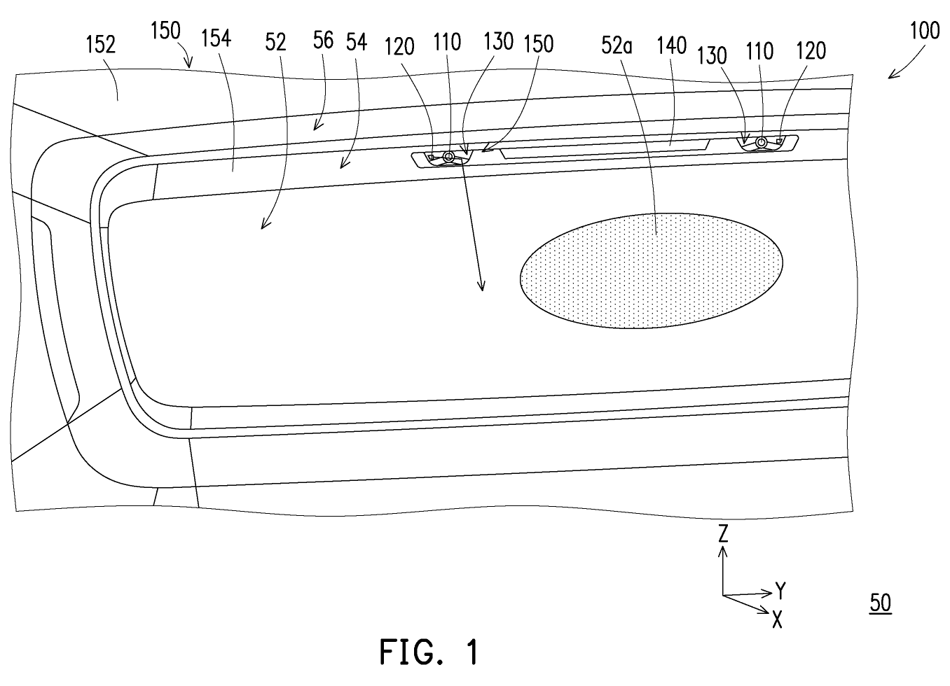

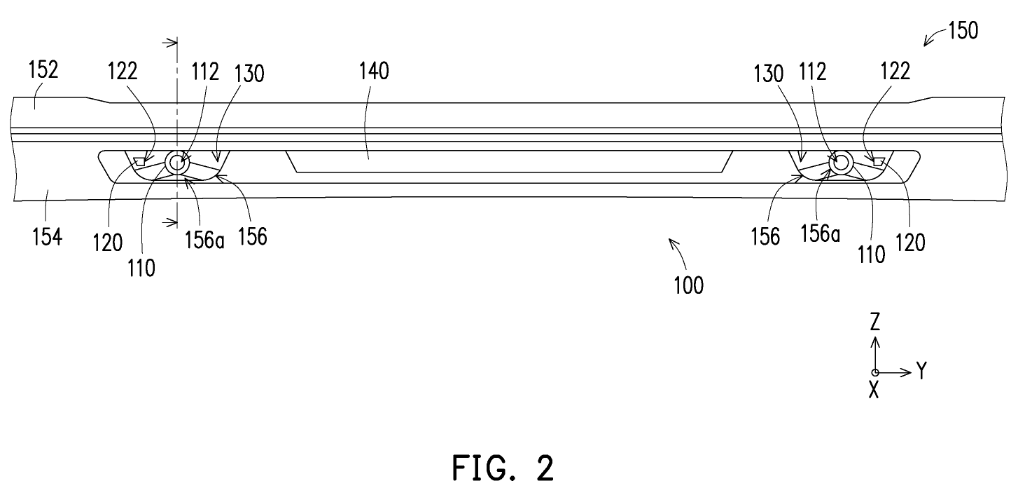

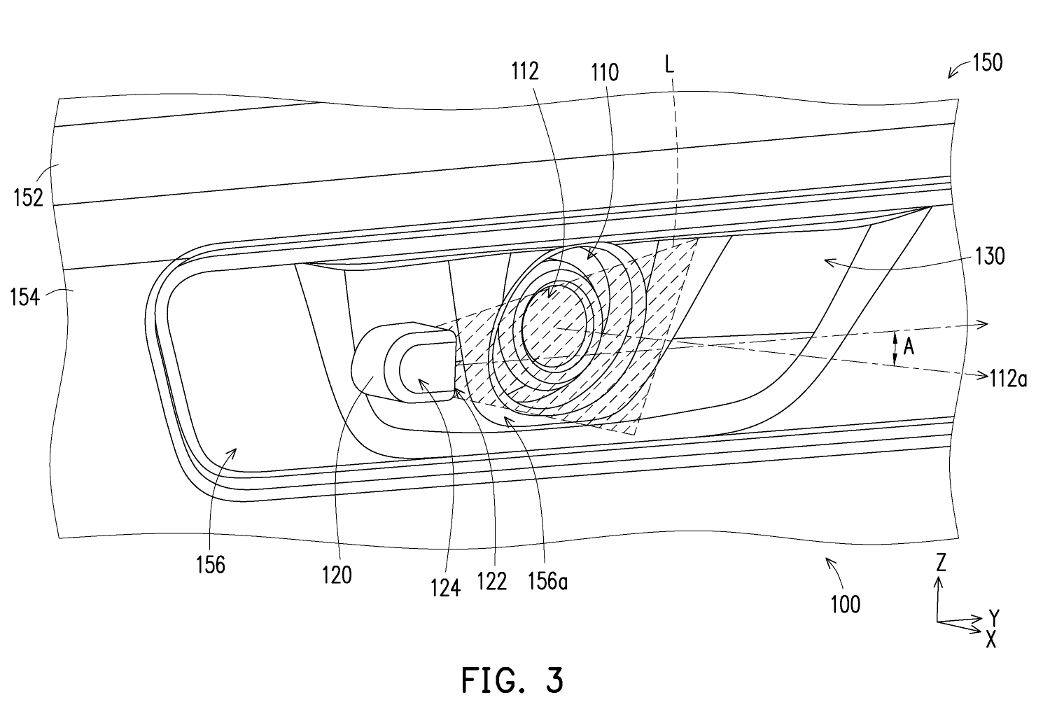

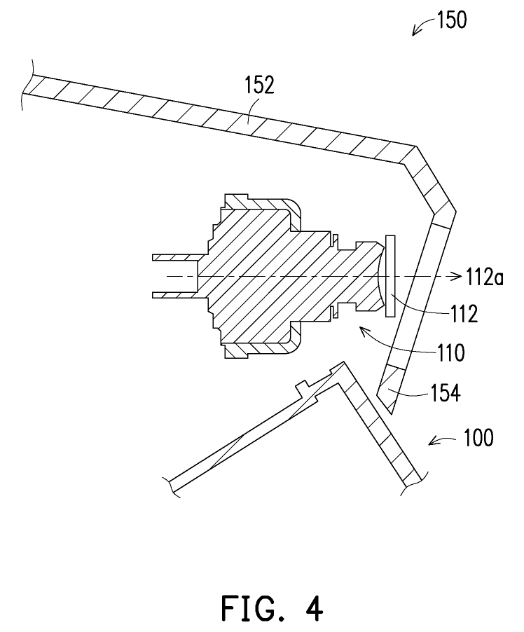

Reference will now be made in detail to exemplary embodiments of the present disclosure, examples of the exemplary embodiments are illustrated in the accompanying drawings. FIG. 1 is a schematic partial perspective view of a vehicle to which a vehicle cleaning structure according to an embodiment of the present disclosure is applied, FIG. 2 is a schematic front view of the vehicle cleaning structure shown in FIG. 1, FIG. 3 is a schematic partially enlarged view of the vehicle cleaning structure shown in FIG. 1, and FIG. 4 is a schematic cross-sectional view of the vehicle cleaning structure shown in FIG. 1 at an imaging component. The specific structure of a vehicle cleaning structure 100 according to an embodiment of the present disclosure will be described below with reference to FIG. 1 to FIG. 4. However, these drawings are only some examples of the present disclosure, and the present disclosure is not limited thereto.

Referring to FIG. 1 to FIG. 3, in the present embodiment, the vehicle cleaning structure 100 includes an imaging component 110, a cleaning component 120, and a shielding structure 130. The imaging component 110 is provided above a design surface 52 of a vehicle 50 to acquire external information of the vehicle 50, and includes a lens part 112. The cleaning component 120 includes an outlet 122 from which a liquid L is sprayed toward the lens part 112. The shielding structure 130 is provided above the design surface 52. At least a portion of the outlet 122 of the cleaning component 120 overlaps the lens part 112 in an up-down direction Z of the vehicle 50. The shielding structure 130 and the cleaning component 120 are respectively located on opposite sides of the imaging component 110, and extend along an optical axis 112a of the lens part 112.

Specifically, in the present embodiment, as shown in FIG. 1 to FIG. 3, the imaging component 110 is, for example, a camera including the lens part 112, and is provided outside the vehicle 50 and located above the design surface 52, so as to acquire the external information of the vehicle 50 through the lens part 112 facing the outside (for example, rear side) of the vehicle 50. As an example, the optical axis 112a of the lens part 112 extends, for example, in a direction (that is, front-rear direction X) orthogonal to the up-down direction Z and a left-right direction Y, thereby enabling the lens part 112 to capture images of the outside (for example, rear side) of the vehicle 50. Furthermore, the cleaning component 120 is, for example, a nozzle including the outlet 122. Thus, the cleaning component 120 is able to spray the liquid L toward the lens part 112 through the outlet 122 to clean a surface of the lens part 112. The outlet 122 of the cleaning component 120 overlaps the lens part 112 in the up-down direction Z. That is, the cleaning component 120 and the imaging component 110 arranged offset in the left-right direction Y are adjacent to each other in the up-down direction Z. Hence, the cleaning component 120 is also provided above the design surface 52. In this way, the outlet 122 of the cleaning component 120 is able to spray the liquid L toward the lens part 112 at a short distance (as shown in FIG. 3). Similarly, the shielding structure 130 is provided at a position facing the cleaning component 120 to restrict the sprayed liquid L. Hence, the shielding structure 130 is also provided above the design surface 52. However, as long as the liquid sprayed from the outlet 122 is able to clean the lens part 112 (that is, at least a portion of the outlet 122 overlaps the lens part 112 in the up-down direction Z) and is blocked by the shielding structure 130, the positions of the outlet 122 of the cleaning component 120 and the shielding structure 130 may be adjusted according to needs. The present disclosure does not limit the specific structures and actual positions of the imaging component 110, cleaning component 120, and shielding structure 130, which may be adjusted according to needs.

Furthermore, in the present embodiment, as shown in FIG. 1 to FIG. 3, the shielding structure 130 and the cleaning component 120 are respectively located on opposite sides (for example, right side and left side in FIG. 3) of the imaging component 110. Accordingly, when the cleaning component 120 on the left side in FIG. 3 sprays the liquid L toward the lens part 112 of the imaging component 110 in the center of FIG. 3 through the outlet 122, the liquid L reflected by the lens part 112 is blocked by the shielding structure 130 on the right side in FIG. 3, such that a spray path of the liquid L in the left-right direction Y does not exceed the shielding structure 130. Since the shielding structure 130 extends along the optical axis 112a (for example, extending in the front-rear direction X) of the lens part 112, the shielding structure 130 constitutes a structure that performs blocking in the left-right direction Y and performs guiding in the up-down direction Z. The liquid L sprayed from the cleaning component 120 is blocked by the shielding structure 130 and then flows downward along the shielding structure 130 without splashing over a large area. Accordingly, in the vehicle cleaning structure 100, a splash range of the liquid sprayed from the cleaning component 120 is limited (splashing over a large area is prevented) by the shielding structure 130, and the appearance of the design surface 52 of the vehicle 50 can be maintained. However, the present disclosure does not limit the specific structure and actual position of the shielding structure 130, which may be adjusted according to needs.

By the aforementioned configuration, in the vehicle cleaning structure 100 of the present embodiment, at least a portion of the outlet 122 of the cleaning component 120 overlaps the lens part 112 of the imaging component 110 in the up-down direction Z of the vehicle 50, such that the cleaning component 120 and the imaging component 110 are arranged adjacent to each other, thereby effectively shortening the spray path of the liquid L from the cleaning component 120 to the imaging component 110. In the case where the cleaning component 120 is arranged on the lower side, there is a possibility that the liquid L may spray upward to clean the lens part 112 and then splash downward to the lens part 112 again due to gravity. In the case where the cleaning component 120 is arranged on the upper side and the shielding structure 130 is provided on the lower side opposite thereto, there is a possibility that the liquid L may spray downward to clean the lens part 112, then be bounced by the shielding structure 130 on the lower side and splash upward to the lens part 112 again, and also splash over a large area on the design surface 52 below. Both of the aforementioned approaches are not as good as the vehicle cleaning structure 100 of the present embodiment. In the vehicle cleaning structure 100 of the present embodiment, the shielding structure 130 and the cleaning component 120 are respectively located on opposite sides of the imaging component 110, such that the liquid L sprayed from the cleaning component 120 to the imaging component 110 is blocked by the shielding structure 130, and the liquid L blocked by the shielding structure 130 forms a thin strip shaped stream of water that flows along the shielding structure 130 (extending along the optical axis 112a of the lens part 112) without splashing over a large area. Accordingly, in the vehicle cleaning structure 100, by a simple structure, the liquid L sprayed by the cleaning component 120 can be prevented from splashing over a large area through reflection by the lens part 112, while the appearance of the vehicle 50 can be maintained.

More specifically, in the present embodiment, as shown in FIG. 1 to FIG. 3, the design surface 52 is provided on a rear surface 54 of the vehicle 50, and the imaging component 110 is provided at an upper portion (for example, near the junction between an upper surface 56 and the rear surface 54 of the vehicle 50) of the rear surface 54 of the vehicle 50. In this way, the imaging component 110 is provided at a relatively high position in the up-down direction Z, such as the upper portion of the rear surface 54 of the vehicle 50, thereby acquiring the external information (for example, rear information) of the vehicle 50 in a relatively large range from the relatively high position. The provision of the imaging component 110 does not affect (that is, does not damage the structure or outer shape or the like of the design surface 52) the design surface 52 of the vehicle 50. Even if the imaging component 110, the cleaning component 120, the shielding structure 130, and the like are provided at the upper portion of the rear surface 54 of the vehicle 50 and higher than the design surface 52, since the liquid L sprayed from the cleaning component 120 to the imaging component 110 is blocked by the shielding structure 130 and does not splash over a large area, there is no need to provide a structure such as a wiper that keeps clean the design surface 52 in the vehicle 50. However, in other embodiments not shown, the imaging component 110 and the design surface 52 may also be provided on a front surface or side surface of the vehicle 50. The present disclosure does not limit the actual positions of the imaging component 110 and the design surface 52, which may be adjusted according to needs.

In the present embodiment, as shown in FIG. 1 to FIG. 3, the design surface 52 includes any one of a glass surface provided on the rear surface 54 of the vehicle 50 and an information display surface provided on the rear surface 54 of the vehicle 50. The glass surface provided on the rear surface 54 of the vehicle 50 includes a surface of car window glass used for a car window. The information display surface provided on the rear surface 54 of the vehicle 50 includes a surface of a display panel used around the car window, a portion of the car window, or the whole car window, or a surface of projection glass that serves as a projection screen. In this way, the design surface 52 functions for the appearance of the vehicle 50 (or further provides display information), and needs to be kept clean. On this occasion, even if the imaging component 110, the cleaning component 120, the shielding structure 130, and the like are provided at the upper portion of the rear surface 54 of the vehicle 50 and higher than the design surface 52, since the liquid L sprayed from the cleaning component 120 to the imaging component 110 is blocked by the shielding structure 130 and does not splash over a large area, there is no need to provide a structure such as a wiper that keeps clean the design surface 52 in the vehicle 50. However, the present disclosure does not limit the specific structure of the design surface 52 and the like, which may be adjusted according to needs.

In the present embodiment, as shown in FIG. 1 to FIG. 3, a decorative portion 52a is provided on the design surface 52, and the shielding structure 130 arranged above the design surface 52 does not overlap the decorative portion 52a in a direction (that is, horizontal direction, which may be, but is not limited to, left-right direction Y) orthogonal to the up-down direction Z. That is, the shielding structure 130 is provided at a position offset from the decorative portion 52a on the design surface 52 on the lower side in the horizontal direction (which may be, but is not limited to, left-right direction Y). As an example, the decorative portion 52a is, for example, a trademark (printed pattern) or logo (three-dimensional structure) of a manufacturer, provided at the center of a design surface (for example, a glass surface provided on the rear surface 54 of the vehicle 50). In addition to being an object such as the aforementioned trademark or logo that is constantly present on the design surface 52, the decorative portion 52a may also be a switchable image displayed on the design surface (for example, information display surface provided on the rear surface 54 of the vehicle 50) and capable of being switched on (for example, a display panel performing displaying or a projection screen performing projection) or switched off according to needs. In this way, a liquid sprayed from the cleaning component 120, reflected by the lens part 112 and flowing downward along the shielding structure 130 as described above does not pass through the decorative portion 52a, but flows downward to a non-decorative portion of the design surface 52, thereby keeping clean at least the decorative portion 52a of the design surface 52 and maintaining the appearance of the vehicle 50.

In the present embodiment, as shown in FIG. 1 and FIG. 2, the vehicle cleaning structure 100 further includes a lamp component 140 provided at an upper portion of the rear surface 54 of the vehicle 50. The lamp component 140 is arranged on a center side compared to the imaging component 110 in a width direction (corresponding to left-right direction Y) of the vehicle 50, and the cleaning component 120 is arranged on an outer side than the lens part 112 in the width direction. That is, the cleaning component 120, imaging component 110, shielding structure 130, and lamp component 140 of the vehicle cleaning structure 100 are arranged along the width direction at the upper portion (above the design surface 52) of the rear surface 54 of the vehicle 50. In this way, a vertical width of the vehicle cleaning structure 100 on the rear surface 54 of the vehicle 50 can be reduced while the appearance of the vehicle 50 is maintained. The lamp component 140 is provided on the center side, and the imaging component 110 is provided on at least one of left and right sides of the lamp component 140 (although FIG. 2 shows that the imaging component 110 is provided on both opposite sides, the imaging component 110 may be provided only on one side). The cleaning component 120 is provided on the outer side of the imaging component 110, and the shielding structure 130 is provided between the imaging component 110 and the lamp component 140. In this way, a liquid supply pipe (not shown) of the cleaning component 120 can be connected to the cleaning component 120 from outside without interfering with a cable (not shown) or the like of the imaging component 110 or the lamp component 140. Moreover, it can be prevented that the liquid supply pipe is excessively bent in order to avoid contact with the cable, and the installation of the cleaning component 120 and the liquid supply pipe is facilitated. However, the present disclosure does not limit the specific structure of the lamp component 140 as well as where and whether to provide the lamp component 140, which may be adjusted according to needs.

In the present embodiment, as shown in FIG. 1 to FIG. 4, the vehicle cleaning structure 100 further includes a decorative component 150. The decorative component 150 is provided above the design surface 52 and forms a rear end of the upper surface 56 and an upper end (the junction between the upper surface 56 and the rear surface 54 of the vehicle 50) of the rear surface 54 of the vehicle 50. As an example, the decorative component 150 is provided above glass (corresponding to the design surface 52 herein) provided on a tailgate on a rear side of the vehicle 50, but is not limited thereto (the decorative component 150 may also be provided on a front side or a lateral side). As shown in FIG. 4, the decorative component 150 is configured to have a bent structure with an upper surface 152 (corresponding to the rear end of the upper surface 56) and a rear surface 154 (corresponding to the upper end of the rear surface 54) that intersect with each other, in which the upper surface 152 and the rear surface 154 of the decorative component 150 form an acute angle, and the imaging component 110 is provided on the rear surface 154 of the decorative component 150. In this way, the upper surface 152 of the decorative component 150 covers above the imaging component 110, and is able to serve as a top cover for the imaging component 110 to prevent rainwater or the like from adhering to the surface of the lens part 112. The rear surface 154 of the decorative component 150 extends obliquely downward and frontward, thereby hiding the imaging component 110 deep therein, while the appearance of the vehicle 50 is maintained.

Furthermore, in the present embodiment, as shown in FIG. 1 to FIG. 4, the rear surface 154 of the decorative component 150 is provided with a recess 156 recessed toward the front of the vehicle 50. The imaging component 110 is provided on a bottom surface 156a of the recess 156, and the shielding structure 130 is constituted by a side surface of the recess 156. The cleaning component 120 is provided in the recess 156, and a rear end 124 of the cleaning component 120 is located closer to the front of the vehicle 50 (closer to the bottom surface of the recess 156) than the rear surface 154 of the decorative component 150. That is, a portion of the rear surface 154 of the decorative component 150 is recessed frontward to form the recess 156, and the imaging component 110 and the cleaning component 120 are accommodated in the recess 156. The imaging component 110 is provided, for example, on the bottom surface 156a at a center of the recess 156. The cleaning component 120 is provided, for example, on a side surface on one side (for example, left side in FIG. 3) of the recess 156, and is located inward of the rear surface 154 (that is, not protruding beyond the rear surface 154). A side surface on the other side (for example, right side in FIG. 3) of the recess 156 is configured as the shielding structure 130 (for example, a shielding surface). In this way, the imaging component 110 and the cleaning component 120 can be hidden in the recess 156 that is recessed downward and frontward, thereby maintaining the appearance of the vehicle 50. The cleaning component 120 is able to spray the liquid L toward the lens part 112 at a short distance in the recess 156, and the liquid L can be blocked by the side surface (that is, shielding structure 130) of the recess 156 and be prevented from splashing over a large area. In the vehicle cleaning structure 100, there is no need to provide an additional member that serves as the shielding structure 130, whereby the vehicle cleaning structure 100 is simplified in structure, while the function of preventing the liquid L from splashing as described above is maintained. However, the present disclosure does not limit the specific structure of the decorative component 150, whether to provide the decorative component 150, and the specific structure of the shielding structure 130, which may be adjusted according to needs.

In the present embodiment, as shown in FIG. 2 and FIG. 3, an included angle A formed between a surface (for example but not limited to, a side surface of the recess 156) of the shielding structure 130 and the optical axis 112a of the lens part 112 is less than or equal to 45 degrees. As an example, the shielding structure 130 not only extends along the optical axis 112a (for example, extending in the front-rear direction X) of the lens part 112, but is also provided inclined relative to the lens part 112 in the left-right direction Y. Accordingly, the surface of the shielding structure 130 forms the included angle A with the optical axis 112a (for example, extending in the front-rear direction X) of the lens part 112, and the included angle A is less than or equal to 45 degrees. That is, the surface of the shielding structure 130 is inclined from the front toward the rear in the front-rear direction X and from the inside toward the outside of the recess 156, and faces relatively toward the imaging component 110 and the cleaning component 120 in the recess 156 in the left-right direction Y. In this way, the liquid L sprayed from the cleaning component 120 and reflected by the lens part 112 can be reflected by the surface (with an angle less than or equal to 45 degrees) of the shielding structure 130 and be concentrated toward a side where the imaging component 110 and the cleaning component 120 are located in the recess 156. Accordingly, the shielding structure 130 is able to relatively effectively prevent the liquid L that is sprayed from the cleaning component 120 and reflected by the lens part 112 from splashing over a large area. However, the present disclosure does not limit the specific structure of the surface of the shielding structure 130 or the like, which may be adjusted according to needs.

In summary, in the vehicle cleaning structure of the present disclosure, at least a portion of the outlet of the cleaning component overlaps the lens part of the imaging component in the up-down direction of the vehicle. Accordingly, the cleaning component and the imaging component are arranged adjacent to each other, thereby effectively shortening the liquid spray path from the cleaning component toward the imaging component. The shielding structure and the cleaning component are respectively located on opposite sides of the imaging component. Accordingly, the liquid sprayed from the cleaning component toward the imaging component is blocked by the shielding structure, the liquid blocked by the shielding structure forms a thin strip shaped stream of water that flows along the shielding structure (extending along the optical axis of the lens part) and is prevented from splashing over a large area. Preferably, an included angle formed between the surface of the shielding structure and the optical axis of the lens part is less than or equal to 45 degrees. Accordingly, the shielding structure is able to relatively effectively block the liquid sprayed from the cleaning component and reflected by the lens part from splashing over a large area. Accordingly, in the vehicle cleaning structure of the present disclosure, by a simple structure, the liquid sprayed by the cleaning component can be prevented from splashing over a large area through reflection by the lens part, while the appearance of the vehicle can be maintained.

It should be noted that the above embodiments are merely intended to illustrate the technical solutions of the present disclosure and are not to be construed as limiting the present disclosure. Although the present disclosure has been described in detail with reference to the foregoing embodiments, one of ordinary skill in the art should understand that modifications may still be made to the technical solutions described in the foregoing embodiments or equivalent replacements may be made to some or all of the technical features thereof. However, these modifications or replacements do not cause the essence of the corresponding technical solutions to depart from the scope of the technical solutions of the embodiments of the present disclosure.

What is claimed is:

1. A vehicle cleaning structure, comprising:
an imaging component, provided above a design surface of a vehicle to acquire external information of the vehicle, and comprising a lens part;
a cleaning component, comprising an outlet from which a liquid is sprayed toward the lens part; and
a shielding structure, provided above the design surface, wherein
at least a portion of the outlet of the cleaning component overlaps the lens part in an up-down direction of the vehicle;
the shielding structure and the cleaning component are respectively located on opposite sides of the imaging component; and
the shielding structure extends along an optical axis of the lens part.

2. The vehicle cleaning structure according to claim 1, wherein
the design surface is provided with a decorative portion; and
the shielding structure arranged above the design surface does not overlap the decorative portion in a direction orthogonal to the up-down direction.

3. The vehicle cleaning structure according to claim 1, wherein
the design surface is provided on a rear surface of the vehicle; and
the imaging component is provided at an upper portion of the rear surface of the vehicle.

4. The vehicle cleaning structure according to claim 1, wherein
the design surface comprises a glass surface provided on a rear surface of the vehicle.

5. The vehicle cleaning structure according to claim 1, wherein
the design surface comprises an information display surface provided on a rear surface of the vehicle.

6. The vehicle cleaning structure according to claim 1, further comprising:
a lamp component, provided at an upper portion of a rear surface of the vehicle, wherein
the lamp component is arranged on a center side compared to the imaging component in a width direction of the vehicle; and
the cleaning component is arranged on an outer side than the lens part in the width direction.

7. The vehicle cleaning structure according to claim 1, further comprising:
a decorative component, provided above the design surface and forming a rear end of an upper surface and an upper end of a rear surface of the vehicle, wherein
an upper surface and a rear surface of the decorative component form an acute angle; and
the imaging component is provided on the rear surface of the decorative component.

8. The vehicle cleaning structure according to claim 7, wherein
the rear surface of the decorative component is provided with a recess recessed toward a front of the vehicle;
the imaging component is provided on a bottom surface of the recess; and
the shielding structure is constituted by a side surface of the recess.

9. The vehicle cleaning structure according to claim 8, wherein
the cleaning component is provided in the recess; and
a rear end of the cleaning component is located closer to the front of the vehicle than the rear surface of the decorative component.

10. The vehicle cleaning structure according to claim 1, wherein
an included angle formed between a surface of the shielding structure and the optical axis of the lens part is less than or equal to 45 degrees.
